(19) United States
(12) Patent Application Publication
(10) Pub. No.: US 2008/0143456 A1
(43) Pub. Date: Jun. 19, 2008

(54) BAND COMBINING FILTER

(75) Inventor: John David Rhodes, Menston (GB)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(73) Assignee: ISOTEK ELECTRONICS LIMITED, Leeds (GB)

(21) Appl. No.: 11/611,653

(22) Filed: Dec. 15, 2006

(51) Int. Cl. H01P 5/18

(52) U.S. Cl. 333/110

(57) ABSTRACT

A band combining filter comprising a plurality of cascaded directional filters,
each directional filter having at least two inputs and at least two outputs, the nth directional filter being arranged such that the output signals O₁ and O₂ from the first and second outputs are related to the input signals I₁, I₂ to the first and second inputs by the relation

$$( \begin{matrix}{O}_{1} \\ {O}_{2}\end{matrix} ) = ( \begin{matrix}{R}_{n 1} & {T}_{n 2} \\ {T}_{n 1} & {R}_{n 2}\end{matrix} ) ( \begin{matrix}{I}_{1} \\ {I}_{2}\end{matrix} )$$

with R and T being reflection and transmission functions respectively,
characterised in that
the directional filters are connected in a cascade with the first and second inputs of the nth directional filter being connected to the first and second outputs of the (n-1)th directional filter respectively in the cascade.

The present invention relates to a band combining filter and a signal transmitter including such a filter. More particularly, but not exclusively, the present invention relates to a band combining filter comprising a plurality of directional filters connected together in a cascade.

There is an increasing demand to combine different types of communications systems on to a common antenna by subdividing a communication band by frequency allocation. There are several known techniques by which this may be accomplished however the need for a high power and high linearity makes known systems complex and expensive.

The band combining filter according to the invention seeks to overcome this problem.

Accordingly, in a first aspect the present invention provides a band combining filter comprising a plurality of cascaded directional filters,

each directional filter having at least two inputs and at least two outputs, the nth directional filter being arranged such that the output signals O₁ and O₂ from the first and second outputs are related to the input signals I₁, I₂ to the first and second inputs by the relation

$$( \begin{matrix}{O}_{1} \\ {O}_{2}\end{matrix} ) = ( \begin{matrix}{R}_{n 1} & {T}_{n 2} \\ {T}_{n 1} & {R}_{n 2}\end{matrix} ) ( \begin{matrix}{I}_{1} \\ {I}_{2}\end{matrix} )$$

with R and T being reflection and transmission functions respectively,

characterised in that

the directional filters are connected in a cascade with the first and second inputs of the nth directional filter being connected to the first and second outputs of the (n-1)th directional filter respectively in the cascade.

The use of cascaded directional filters provides a compact band combining filter providing complex filtering characteristics with a relatively simple filter structure.

Preferably the directional filters are symmetric and reciprocal filters with Rₙ₁=Rₙ₂=Rₙ and Tₙ₁=Tₙ₂=Tₙ.

Preferably, at least one of the directional filters comprises

a first signal splitter having a first input port connected to the first input and a first output port connected to the first output;

a second signal splitter having a second input port connected to the second input and a second output port connected to the second output;

each of the first and second signal splitters having first and second connection ports;

the two first connection ports being connected together by a first filter;

the two second connection ports being connected together by a second filter.

The first and second signal splitters can be 3dB hybrids.

The first and second filters can be identical.

Alternatively, the first and second filters can be different to each other.

Preferably, the first and second filters of at least one directional filter are at least one of a low pass filter, high pass filter, band stop filter or band pass filters.

Preferably, the first and second filters of at least one directional filter are frequency independent.

The band combining filter can comprise first and second directional filters only.

The first and second filters of the first directional filter can be at least one of a low pass filter, a high pass filter, a band stop filter or band pass filter and the first and second filters of the second directional filter can be frequency independent.

Preferably, the low pass filter is a ladder filter, preferably of even order.

In a further aspect of the invention there is provided a signal transmitter comprising

a band combining filter comprising
a plurality of cascaded directional filters,
each directional filter having at least two inputs and at least two outputs, the nth directional filter being arranged such that the output signals O₁ and O₂ from the first and second outputs are related to the input signals I₁, I₂ to the first and second inputs by the relation

$$( \begin{matrix}{O}_{1} \\ {O}_{2}\end{matrix} ) = ( \begin{matrix}{R}_{n 1} & {T}_{n 2} \\ {T}_{n 1} & {R}_{n 2}\end{matrix} ) ( \begin{matrix}{I}_{1} \\ {I}_{2}\end{matrix} )$$

with R and T being reflection and transmission functions respectively,
characterised in that
the directional filters are connected in a cascade with the first and second inputs of the nth directional filter being connected to the first and second outputs of the (n-1)th directional filter respectively in the cascade;

a first signal source in electrical communication with the first input of the first directional filter in the cascade;

a second signal source in electrical communication with the second input of the first directional filter in the cascade; and

an antenna connected to an output of the last directional filter in the cascade.

The present invention will now be described by way of example only, and not in any limitative sense, with reference to the accompanying drawings in which

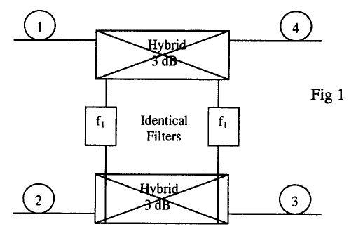

FIG. 1 shows a directional filter;

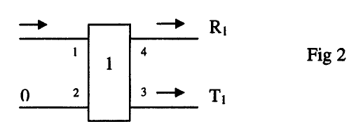

FIG. 2 shows the directional filter of FIG. 1 in schematic form;

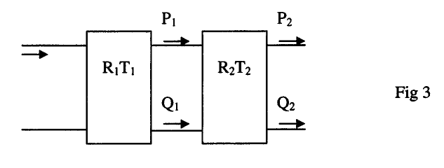

FIG. 3 shows two directional filters connected in a cascade;

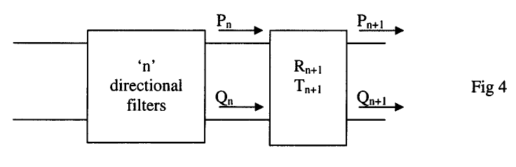

FIG. 4 shows in schematic form N directional filters connected in a cascade;

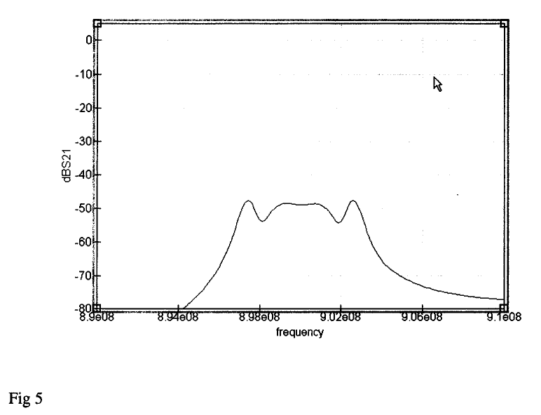

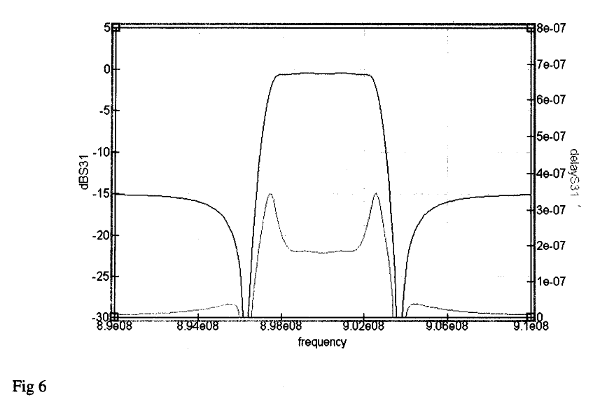

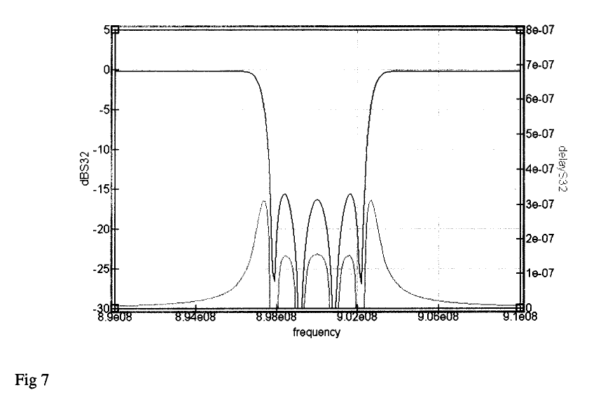

FIGS. 5 to 7 show the isolation, amplitude and delay plots of a band combining filter according to the invention.

In its simplest form the directional filter is a 4-port device consisting of two identical filters and a pair of 3 dB hybrids as shown in FIG. 1.

If the scattering matrix of one of the reciprocal filters is:

$$[ s ] = [ \begin{matrix}{s}_{11} & {s}_{21} \\ {s}_{21} & {s}_{22}\end{matrix} ] \qquad 1$$

and a signal is applied at port (1), then none of the power is reflected at port 1; port 2 is totally isolated and the transfer characteristics to ports 3 and 4 are:

T₄=jS₁₁

T₃=jS₂₁ 2

If the filters are assumed to be lossless then

$${\vert {T}_{4} \vert}^{2} + {\vert {T}_{3} \vert}^{2} = 1 \qquad 3$$

Multipath Directional Filters

To simplify the analysis, it will be assumed that the filters are symmetrical, although this is not a necessary requirement. A single directional filter is then defined in FIG. 2,

and for a lossless network:

$${\vert {T}_{1} \vert}^{2} + {\vert {R}_{1} \vert}^{2} = 1 \qquad 4$$

Cascading two directional filters is shown in FIG. 3.

The outputs are:

P₁=R₁, Q₁=T₁ 5

and

P₂=P₁R₂+Q₁T₂

Q₂=P₁T₂+Q₁R₂ 6

For a lossless network then

$${\vert {P}_{2} \vert}^{2} + {\vert {Q}_{2} \vert}^{2} = 1 \qquad 7$$

For the general case containing n directional filters if an additional device is added one has the situation shown in FIG. 4,

where

Pₙ₊₁=PₙRₙ₊₁+QₙTₙ₊₁

Qₙ₊₁=PₙTₙ₊₁+QₙRₙ₊₁ 8

and for the lossless case.

$${\vert {P}_{n + 1} \vert}^{2} + {\vert {Q}_{n + 1} \vert}^{2} = 1 \qquad 9$$

Thus, the recurrence formula for generating the overall network performance is,

Pᵣ₊₁=PᵣRᵣ₊₁+QᵣTᵣ₊₁

Qᵣ₊₁=PᵣTᵣ₊₁+QᵣRᵣ₊₁ 10

for r=1→n, with the initial conditions,

P₁=R₁, Q₁=T₁ 11

Design Example for a Cascade of Two Directional Filters

For the case of two directional filters in cascade one has the network equations given in equation 6. Let the first network consist of two lowpass ladder networks of even degree where one may write,

$$\begin{matrix}{T}_{1} = \frac{- 1}{{D}_{2 n} ( p )} \\ and & 12 \\ {R}_{1} = \frac{j {N}_{n} ( {p}^{2} )}{{D}_{2 n} ( p )} & 13\end{matrix}$$

Where N and D are known terms in network theory.

For a lossless network

D₂ₙ(p)D₂ₙ(−p)=1+Nₙ²(p²) 14

Let the second network be frequency independent defined as:

$${T}_{2} = \frac{- j}{\sqrt{1 + {ɛ}^{2}}} \\ {R}_{2} = \frac{ɛ}{\sqrt{1 + {ɛ}^{2}}} \qquad 15$$

which can be realised as a single proximity coupler with ‘ε’ relatively small.

Hence,

$$\begin{matrix}\begin{matrix}{P}_{2} = \frac{j ɛ {N}_{n} ( {p}^{2} )}{\sqrt{1 + {ɛ}^{2}} {D}_{2 n} ( p )} + \frac{j}{\sqrt{1 + {ɛ}^{2}} {D}_{2 n} ( p )} \\ = \frac{j ( ɛ {N}_{n} ( {p}^{2} ) + 1 )}{\sqrt{1 + {ɛ}^{2}} {D}_{2 n} ( p )}\end{matrix} \\ and & 16 \\ {Q}_{2} = \frac{{N}_{n} ( {p}^{2} ) - ɛ}{\sqrt{1 + {ɛ}^{2}} {D}_{2 n} ( p )} & 17\end{matrix}$$

Hence, the overall group delay is the same as the ladder filter and

$$\begin{matrix}{\vert {P}_{2} \vert}^{2} = \frac{{[ ɛ {N}_{n} ( - {ω}^{2} ) + 1 ]}^{2}}{( 1 + {ɛ}^{2} ) [ 1 + {N}_{n}^{2} ( - {ω}^{2} ) ]} \\ {\vert {Q}_{2} \vert}^{2} = \frac{{[ - {N}_{n} ( - {ω}^{2} ) + ɛ ]}^{2}}{( 1 + {ɛ}^{2} ) [ 1 + {N}_{n}^{2} ( - {ω}^{2} ) ]} \\ If then & 18 \\ {N}_{n} ( - {ω}^{2} ) = - ɛ ( cos [ 2 n {cos}^{- 1} ω ] - 1 ) & 19 \\ {\vert {P}_{2} \vert}^{2} = \frac{{[ 1 + {ɛ}^{2} - {ɛ}^{2} cos [ 2 n {cos}^{- 1} ω ] ]}^{2}}{( 1 + {ɛ}^{2} ) [ 1 + {{ɛ}^{2} ( cos [ 2 n {cos}^{- 1} ω ] - 1 )}^{2} ]} \\ and & 20 \\ {\vert {Q}_{2} \vert}^{2} = \frac{{ɛ}^{2} {cos}^{2} [ 2 n {cos}^{- 1} ω ]}{( 1 + {ɛ}^{2} ) [ 1 + {{ɛ}^{2} ( cos [ 2 n {cos}^{- 1} ω ] - 1 )}^{2} ]} & 21\end{matrix}$$

which for ‘ε’ small is approximately equiripple in the passband −1≦ω≦+1

The maximum value of [P₂]² in the passband is

$$\frac{1}{1 + {ɛ}^{2}}$$

and in the stopband [Q₂]² for large ‘ω’ approaches

$$\frac{1}{1 + {ɛ}^{2}}$$

If this level is chosen as approximately 15 dB, then for n=2 we have the isolation, amplitude and delay plots as a function of frequency shown in FIGS. 5, 6 and 7, for signal inputs at ports 1 and 2 with a common output at port 3 where the device has been scaled to 900 MHz with a 4.4 MHz bandwidth. Network 2 is a 15 dB directional coupler and the ladder networks in network 1 are defined by:

$${\vert {R}_{1} \vert}^{2} = \frac{{{ɛ}^{2} ( cos [ 2 n {cos}^{- 1} ω ] - 1 )}^{2}}{1 + {{ɛ}^{2} [ cos [ 2 n {cos}^{- 1} ω ] - 1 ]}^{2}} \qquad 22$$

This may be factorised in the normal way and synthesised as a 2n th degree ladder structure.

The band combining filter of the invention shows a high degree of uniformity in amplitude and phase across a wide range of frequency making it suitable for signal combining applications.

Cascaded directional filters can provide a compact band combining filter which can provide complex filtering characteristics with relatively simple filter structures. A 4th degree example operating at 900 MHz has been given which is suitable for combining a

UMTS channel with an existing GSM system. Furthermore, due to its simplicity, it may readily be reconfigured by tuning the resonant frequencies of the resonators.

Whilst only an example comprising a fourth degree filter and two directional filters has been provided other examples are possible comprising higher order filters or larger numbers of directional filter stages. All show the advantages according to the invention.

Similarly, alternative to low pass ladder networks for the first and second filters of the directional filters may be alternative low pass filter types, high pass filters, band stop filters and band pass filters.

1. A band combining filter comprising ;
a plurality of cascaded directional filters,
each directional filter having at least two inputs and at least two outputs, the nth directional filter being arranged such that the output signals O₁ and O₂ from the first and second outputs are related to the input signals I₁, I₂ to the first and second inputs by the relation
$$( \begin{matrix}{O}_{1} \\ {O}_{2}\end{matrix} ) = ( \begin{matrix}{R}_{n 1} & {T}_{n 2} \\ {T}_{n 1} & {R}_{n 2}\end{matrix} ) ( \begin{matrix}{I}_{1} \\ {I}_{2}\end{matrix} )$$
with R and T being reflection and transmission functions respectively,
characterised in that the directional filters are connected in a cascade with the first and second inputs of the nth directional filter being connected to the first and second outputs of the (n-1)th directional filter respectively in the cascade.

2. A band combining filter as claimed in claim 1, wherein the directional filters are symmetric and reciprocal filters with Rₙ₁=Rₙ₂=Rₙ and Tₙ₁=Tₙ₂=Tₙ.

3. A band combining filter as claimed in claim 1, wherein at least one of the directional filters comprises;
a first signal splitter having a first input port connected to the first input and a first output port connected to the first output;
a second signal splitter having a second input port connected to the second input and a second output port connected to the second output;
each of the first and second signal splitters having first and second connection ports;
the two first connection ports being connected together by a first filter;
the two second connection ports being connected together by a second filter.

4. A band combining filter as claimed in claim 3, wherein the first and second signal splitters are 3 dB hybrids.

5. A band combining filter as claimed in claim 3, wherein the first and second filters are identical.

6. A band combining filter as claimed in claim 3, wherein the first and second filters are different to each other.

7. A band combining filter as claimed in claim 3, wherein the first and second filters of at least one directional filter are at least one of a low pass filter, high pass filter, band stop filter or band pass filter.

8. A band combining filter as claimed in claim 3, wherein the first and second filters of at least one directional filter are frequency independent.

9. A band combining filter as claimed in claim 1, comprising first and second directional filters only.

10. A band combining filter as claimed in claim 9, wherein the first and second filters of the first directional filter are at least one of a low pass filter, a high pass filter, a band stop filter or band pass filter and the first and second filters of the second directional filter are frequency independent.

11. A band combining filter as claimed in claim 10, wherein the low pass filter is a ladder filter of even order.

12. A signal transmitter comprising;
a plurality of cascaded directional filters,
each directional filter having at least two inputs and at least two outputs, the nth directional filter being arranged such that the output signals O₁ and O₂ from the first and second outputs are related to the input signals I₁, I₂ to the first and second inputs by the relation
$$( \begin{matrix}{O}_{1} \\ {O}_{2}\end{matrix} ) = ( \begin{matrix}{R}_{n 1} & {T}_{n 2} \\ {T}_{n 1} & {R}_{n 2}\end{matrix} ) ( \begin{matrix}{I}_{1} \\ {I}_{2}\end{matrix} )$$
with R and T being reflection and transmission functions respectively,
the directional filters are connected in a cascade with the first and second inputs of the nth directional filter being connected to the first and second outputs of the (n-1)th directional filter respectively in the cascade,
a first signal source in electrical communication with the first input of the first directional filter in the cascade;
a second signal source in electrical communication with the second input of the first directional filter in the cascade; and
an antenna connected to an output of the last directional filter in the cascade.

13. (canceled)

14. (canceled)

15. A signal transmitter as claimed in claim 12, wherein the directional filters are symmetric and reciprocal filters with Rₙ₁=Rₙ₂=Rₙ and Tₙ₁=Tₙ₂=Tₙ.

16. A signal transmitter as claimed in claim 1, wherein at least one of the directional filters comprises;
a first signal splitter having a first input port connected to the first input and a first output port connected to the first output;
a second signal splitter having a second input port connected to the second input and a second output port connected to the second output;
each of the first and second signal splitters having first and second connection ports;
the two first connection ports being connected together by a first filter;
the two second connection ports being connected together by a second filter.

17. A signal transmitter as claimed in claim 16, wherein the first and second signal splitters are 3 dB hybrids.

18. A signal transmitter as claimed in claim 16, wherein the first and second filters are identical.

19. A signal transmitter as claimed in claim 16, wherein the first and second filters are different to each other.

20. A signal transmitter as claimed in claim 16, wherein the first and second filters of at least one directional filter are at least one of a low pass filter, high pass filter, band stop filter or band pass filter.

21. A signal transmitter as claimed in claim 16, wherein the first and second filters of at least one directional filter are frequency independent.

22. A signal transmitter as claimed in claim 12, comprising first and second directional filters only.

23. A signal transmitter as claimed in claim 22, wherein the first and second filters of the first directional filter are at least one of a low pass filter, a high pass filter, a band stop filter or band pass filter and the first and second filters of the second directional filter are frequency independent.

24. A signal transmitter as claimed in claim 23, wherein the low pass filter is a ladder filter of even order.
